(19) United States
(12) Patent Application Publication
(10) Pub. No.: US 2026/0089110 A1
(43) Pub. Date: Mar. 26, 2026

(54) ON-DEMAND UPLINK BANDWIDTH ALLOCATION

(71) Applicant: Hughes Network Systems, LLC, Germantown, MD (US)

(72) Inventors: Venkat Ganesan, Germantown, MD (US); Eddie Beal, Germantown, MD (US); Fernando Secali de Oliveira Filho, Germantown, MD (US)

(21) Appl. No.: 18/898,032

(22) Filed: Sep. 26, 2024

(51) Int. Cl. H04L 47/2408; H04B 7/185; H04L 47/2475; H04L 47/76

(52) U.S. Cl. CPC H04L 47/2408; H04B 7/18586; H04L 47/2475; H04L 47/76

(57) ABSTRACT

Methods, systems, and apparatus, including computer programs encoded on computer storage media, for allocation uplink bandwidth. In some implementations, a method includes a terminal that transmits a request for streaming media to a connected client device. The terminal obtains a classification for a flow of packets related to the streaming media, wherein the classification indicates a type of the streaming media. Based on the classification, the terminal requests for a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media. The terminal receives allocations of uplink bandwidth. The terminal uses the uplink bandwidth to transmit a request for subsequent data.

### TECHNICAL FIELD

This specification relates generally to communication systems, including systems that provide periodic uplink bandwidth allocation for terminal transmissions over wireless communication channels.

### BACKGROUND

Satellite communication systems often attempt to service clients with high efficiency. Often, such satellite communication systems desire allocating an optimal amount of network resources to various terminals to ensure clients are provided with a high-level service. However, disruptions in a satellite communication link, communication delays caused by the long distances between the devices, and individualized requirements for specific client device, to name a few examples, can often severely hamper a satellite communication system's ability to effectively service their clients.

### SUMMARY

In some implementations, a satellite communication system can enhance communications for a terminal over a satellite communication link. The satellite communication system can include multiple terminals, a gateway system, and a satellite that relays communications between the multiple terminals and the gateway system. Each of the multiple terminals can connect to one or more client devices that can request or provide data, which is then transmitted over the satellites to the gateway system.

In some implementations, when a terminal requests for data from the gateway system to provide to a connected client device, the gateway system can generate uplink bandwidth allocations for the requesting terminal and deliver the uplink bandwidth allocations in an ongoing and periodic fashion. The gateway system can transmit a bandwidth allocation for the terminal over the satellite in a periodic and ongoing basis. In this manner, the terminal does not need to request for uplink bandwidth from the gateway system each time the terminal requests for data to provide to its connected client device, reducing overall system latency. Instead, the terminal can transmit the connected client device's request using the previously provided uplink bandwidth allocation back to the gateway system. This reduces delays the connected client device will experience, by avoiding the need to wait for the terminal to request and receive uplink bandwidth allocation for each transmission. In addition, this technique can ensure that an appropriate amount of uplink bandwidth allocation is maintained for the corresponding terminal over time to support smooth streaming.

In many wireless systems, standard operation grants terminals a very limited amount of uplink allocation bandwidth, such as a small amount each frame or series of frames so a terminal can transmit requests for larger allocations of uplink bandwidth. This technique preserves efficiency by conserving limited spectrum resources and allows terminals to request bandwidth precisely for the amount of data that is queued for transmission. However, requiring a separate uplink bandwidth allocation request for many of most transmissions also causes significant latencies that can reduce the performance of media streaming and other data transfers.

For example, when a device plays a media stream, the device often makes many requests to the server that provides the content over the network, potentially hundreds or thousands of requests over the course of playback. Many audio and video streams are divided into small segments, and the player repeatedly requests additional segments as playback proceeds. When streaming media over a satellite connection, such as using a geostationary (GEO) satellite and time-division multiple access (TDMA), the latency for obtaining bandwidth can be significant and may be incurred for each request for media content segments. Traditionally, each request for an additional media segment is preceded by a network round-trip delay for the terminal to request uplink bandwidth and receive an indication of the granted allocation, before the request for the media segment can even be transmitted, which incurs yet further latency. As a result, the delays can cause the media player to reach the end of the buffer while waiting for additional content, which causes stuttering and pauses.

To improve the smoothness and reliability of streaming media playback over satellite networks, the system can maintain an ongoing reservation of bandwidth for terminals that are identified as playing streaming media. For example, when a streaming media packet flow is detected, a satellite terminal (e.g., a very small aperture terminal (VSAT)) can request that a repeated or ongoing allocation of uplink bandwidth be made during the streaming media playback. An inroute group manager (IGM) of the gateway system can create the reservation and provide repeated uplink bandwidth based on the reservation, so the terminal repeatedly receives new uplink bandwidth allocations based on the reservation, without the need to request new uplink bandwidth for each transmission. As a result, during streaming media playback, when the device playing the streaming media repeatedly issues new requests for additional segments of the streaming media, the terminal can send the requests over the satellite connection without needing to wait for the delay of requesting and receiving new bandwidth allocations. When the device issues a new request for a segment of media content, in many cases the terminal will have already received an allocation of upcoming uplink bandwidth based on the reservation and so can transmit the request very quickly after receiving the request from the connected device. In other cases, even if uplink allocation is not immediately available upon receiving a request from a device, the allocation based on the reservation may still be provided independent of the new request (e.g., without needing to be specifically requested and received based on the new request) and the allocation can be received more quickly than the latency that would be incurred by a round-trip network delay for requesting and receiving allocation without the reservation. In some implementations, the system provides a predetermined level of uplink bandwidth allocation based on the reservation, such as 40 kbits/sec, 50 kbits/sec, or another amount, etc. The reservation and associated repeated bandwidth allocation can continue while the media streaming continues, such as until an event such as reaching the end of the media playback, termination of the connection or packet flow associated with the streaming media, activity falling below a threshold, or a timeout period elapses.

In some cases, when a connected client device initiates an application, such as a streaming service application, the connected client device transmits a request to its corresponding terminal for streaming data associated with the streaming service application. In response, the corresponding terminal transmits a request over the satellite link to the gateway system for the streaming data. The gateway system can communicate with a service provider to request for the streaming media and insert data or flags into packets of the streaming media that indicate a type of the streaming media. In response, the gateway system can transmit the streaming media with the modified packets back to the terminal.

The terminal can receive the streaming media and determine from the flags in the streaming media that the connected client device is executing a particular application that requires streaming media. In response, the terminal can generate and transmit a request to the gateway system for periodic uplink bandwidth allocation. The uplink bandwidth allocation request provides the terminal with a medium to transmit to the gateway the connected client device's request for the streaming data at a particular time and frame. The gateway system can designate an uplink bandwidth allocation for the terminal and transmit the uplink bandwidth allocation to the terminal over the satellite link periodically and in an ongoing manner. After receiving the uplink bandwidth allocation from the gateway system, the terminal can selectively transmit the connected client device's request for the streaming data back to the gateway system using the designated uplink bandwidth allocation. The gateway system can obtain the streaming data based on the connected client device's request and transmit the streaming data back to the terminal, which subsequently provides the streaming data back to the connected client device to execute on the streaming service application.

When the connected client device determines one or more additional segments of streaming data is required, e.g., the streaming application has played a threshold amount of the streaming data, the connected client device transmits another request to the corresponding terminal for the additional segments of streaming data, and the above process repeats. This process can be cumbersome and cause significant delays for the connected client device due to various delays, e.g., the terminal having to request for an uplink bandwidth allocation from the gateway system, the terminal waiting for the uplink bandwidth allocation from the gateway system, and the terminal transmitting the request once the uplink bandwidth allocation from the gateway system is finally received. These delays can cause increased latency during execution of the streaming application at the connected client device and non-continuous streaming of data, which may frustrate users. These delays may be further exacerbated by the nature of the satellite communication system itself, which creates delays due to large geographic distances between the terminal and the gateway system, disruptions over the satellite communication link, and physical distortions over the satellite communication link, to name a few examples.

In some implementations, the satellite communication system can proactively provision uplink bandwidth allocations to terminals to reduce delays at connected client devices. For instance, when a terminal detects that a connected device is receiving or playing streaming media, the terminal can request an ongoing reservation of uplink bandwidth to allow requests for segments of the streaming media to be sent with low latency. In some cases, the terminal can send a request to the gateway system when a connected client device requests for data from a recently launched application. The gateway system can receive the request and generate a reservation of uplink bandwidth allocations to provide to the terminal on a periodic and ongoing basis. By proactively allocating and providing the uplink bandwidth allocations to the terminal, the gateway ensures the terminal has the uplink bandwidth allocation without adding the round-trip delay of an allocation request and response for each streaming media segment. In other words, a single request for the reservation from the terminal can result in multiple repeated allocations to the terminal over the course of streaming media playback, with uplink bandwidth being allocated each time before the connected device needs or requests to transfer data. In this manner, the terminal automatically receives the allocations of uplink bandwidth with designated properties (e.g., such as a particular minimum throughput) so that the terminal has allocated bandwidth available as soon as, or very shortly after, the connected client device provides data to transmit.

In some implementations, a method includes: transmitting, over a satellite connection, a request for streaming media to a connected client device; obtaining, over the satellite connection, a classification for a flow of packets related to the streaming media, wherein the classification indicates a type of the streaming media; based on the classification for the flow of packets, requesting, over the satellite connection, a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media; receiving allocations of uplink bandwidth on the satellite connection for the streaming media created based on the requested reservation over the series of future communication frames; and using the uplink bandwidth that was allocated based on the reservation to transmit, over the satellite connection, a request for subsequent data of the streaming media to provide to the connected client device.

Other embodiments of these and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the repeated allocations are made based on the reservation without subsequent requests from a terminal for the uplink bandwidth for the streaming media.

In some implementations, transmitting the request for the streaming media to the connected client device includes transmitting, over the satellite connection, the request for streaming media to the connected client device for an application service that presents the streaming media at the connected client device.

In some implementations, obtaining the classification for the flow of packets related to the streaming media includes: obtaining, over the satellite connection, the flow of packets related to the streaming media to provide to the connected client device; and determining the classification for the flow of packets by identifying the classification within one or more headers of the flow of packets, wherein the classification indicates the type of the streaming media.

In some implementations, determining the classification for the flow of packets by identifying the classification within the one or more headers of the flow of packets includes determining a Differentiated Services Code Point (DSCP) that identifies the type of the streaming media requested by the connected client device.

In some implementations, requesting, over the satellite connection, the reservation of the periodic uplink bandwidth for the connected client device includes: determining characteristics of the reservation of the periodic uplink bandwidth for the connected client device, wherein the characteristics comprise at least one of an amount of bandwidth, a type of service related to the streaming media for the connected client device, and a frequency with which the periodic reservation is to be provided; and based on the classification for the flow of packets, transmitting, over the satellite connection, a request for the reservation of periodic uplink bandwidth for the connected client device, wherein the request for the reservation of periodic uplink bandwidth comprises the determined characteristics for creation of the repeated allocations.

In some implementations, wherein the reservation is requested includes based on the classification for the flow of packets, requesting, over the satellite connection, the reservation of periodic uplink bandwidth for the connected client device before receiving a request from the connected client device for one or more portions of the streaming media.

In some implementations, wherein the reservation is requested while the connected client device continues to receive or play the streaming media includes requesting, over the satellite connection, the reservation of periodic uplink bandwidth for the connected client device which causes a gateway to provide the repeated allocation of the uplink bandwidth for the connected client device at a periodic basis until the streaming media is no longer played at the connected client device.

In some implementations, receiving the allocations of uplink bandwidth on the satellite connection for the streaming media based on the requested reservation over the series of future communication frames includes receiving, from an inroute group manager at a gateway and over the satellite connection, the allocations of uplink bandwidth at a designated interval over the series of the future communication frames.

In some implementations, using the uplink bandwidth that was allocated based on the reservation to transmit the request for subsequent data of the streaming media to provide to the connected client device includes: in response to receiving the uplink bandwidth that was allocated based on the reservation to transmit the request for subsequent data of the streaming media: determining whether demand exists from the connected client device for the subsequent data of the streaming media; and in response to determining the demand does not exist from the connected client device for the subsequent data, discarding the uplink bandwidth that was allocated based on the reservation to transmit the request for subsequent data of the streaming media; or in response to determining the demand does exist from the connected client device for the subsequent data, transmitting, over the satellite connection, a request for the subsequent data of the streaming media using the uplink bandwidth.

In some implementations, the method further includes: monitoring the flow of packets provided to the connected client device; determining a change in the flow of packets based on the monitoring, wherein determining the change in the flow of packets comprises at least of: determining a change in classification of the flow of packets related to the streaming media over a period of time; determining a change in an amount of traffic of the flow of packets related to the streaming media; determining an end of the flow of packets based on the monitoring; determining a change in an internet protocol connection at a gateway related to the flow of packets; or determining the connected client device cancels the flow of packets related to the streaming media; and in response to determining the change in the flow of packets, transmitting, to the gateway, a cancellation of the periodic reservation of uplink bandwidth for the flow of packets.

In some implementations, requesting the reservation of periodic uplink bandwidth for the connected client device includes requesting for a particular amount of bandwidth for the periodic uplink bandwidth over the series of future communication frames.

In some implementations, the particular amount of bandwidth for the periodic uplink bandwidth includes 40 kilobits.

In some implementations, the method further includes: determining a classification of different usages of the flow of packets, wherein the different usages include video playback, advertisement playback, interactive browsing, and one or more previews; and determining, based on the classification of the different usages of the flow of packets, characteristics of the reservation of the periodic uplink bandwidth for the flow of packets, wherein the characteristics of the reservation of the periodic uplink bandwidth includes different allocations based on the different usages of the flow of packets.

In some implementations, the method further includes: providing, to a local classifier, data related to the flow of packets for the streaming media; obtaining, from the local classifier, output data representing the flow of packets related to the streaming media, wherein the local classifier is trained to analyze the flow of packets to detect at least one of (i) the classification for the flow of packets related to the streaming media, (ii) detection of streaming video related to the streaming media, and (iii) a type of service utilized at the connected client device for the streaming media; and based on the output data representing the flow of packets related to the streaming media, requesting, over the satellite connection, the reservation of periodic uplink bandwidth for the flow of packets.

In some implementations, a terminal performs the method.

In some implementations, a method comprises: obtaining, from a service provider, a classification for a flow of packets related to streaming media for a terminal; based on the classification for the flow of packets, applying data indicative of the classification to one or more packets of the flow of packets; after applying the data indicative of the classification, transmitting, over a satellite connection and to the terminal, the one or more packets that include the data indicative of the classification; after transmitting the one or more packets, receiving, from the terminal and over the satellite connection, a request for a reservation of periodic uplink bandwidth for the flow of packets associated with the streaming media; based on the received request from the terminal, creating the reservation that repeatedly allocates uplink bandwidth over a series of future communication frames to carry requests from a connected client device associated with the terminal for the streaming media while the connected client device continues to receive or play the streaming media; and while streaming the media from the service provider, providing, to the terminal and over the satellite connection, the allocations of uplink bandwidth for the streaming media based on the created reservation over the series of future communication frames.

In some implementations, the classification for the flow of packets indicates a type of the streaming media.

In some implementations, applying the data indicative of the classification to the one or more packets of the flow of packets includes applying a Differentiated Services Code Point (DSCP) tag to the one or more packets of the flow of packets, wherein the DSCP tag indicates the type of the streaming media.

In some implementations, applying the data indicative of the classification to the one or more packets of the flow of packets includes one or more of inserting a value of the data indicative of the classification to the one or more packets, XOR'ing the value of the data indicative of the classification to the one or more packets, and masking a header portion of the one or more packets with the value of the data indicative of the classification.

In some implementations, after transmitting the one or more packets, receiving, from the terminal and over the satellite connection, the request for the reservation of the periodic uplink bandwidth for the flow of packets associated with the streaming media, the request including a requested amount of periodic uplink bandwidth and a type of service utilizing the streaming media at the connected client device.

In some implementations, based on the received request from the terminal, creating the reservation that repeatedly allocates the uplink bandwidth over the series of future communication frames to carry the requests from the connected client device associated with the terminal for the streaming media includes creating the reservation that repeatedly allocates the uplink bandwidth over the series of future communication frames in a data table, the data table storing one or more different allocations of uplink bandwidth for a plurality of terminals in a satellite network.

In some implementations, providing the allocations of uplink bandwidth for the streaming media includes transmitting, to the terminal, the allocations of uplink bandwidth for the streaming media that causes the terminal to selectively use the received uplink bandwidth for the flow of packets based on the reservation to request for subsequent data of the streaming media to provide to the connected client device.

In some implementations, the method further includes: detecting a priority of the flow of packets using the obtained classification for the flow of packets related to the streaming media; applying the obtained classification for the flow of packets to one or more categorizations based on the detected priority, the one or more categorizations comprising bulk, streaming, interactive, and conversational; determining an amount of available bandwidth across a plurality of terminals; generating a bandwidth amount for the flow of packets based on the detected priority of the flow of packets and the amount of available bandwidth across the plurality of terminals; and transmitting, over the satellite connection and to the terminal, the flow of packets related to the streaming media using the generated bandwidth amount based on the detected priority of the flow of packets.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are block diagrams that illustrate an example of a system for proactively allocating periodic uplink bandwidth for a terminal.

FIG. 2 is a flow diagram that illustrates an example of a flow diagram for creating and distributing periodic uplink bandwidth allocations for a terminal.

FIG. 3 is a flow diagram that illustrates an example of a process for a terminal to use a requested uplink bandwidth allocation to transmit data for a connected client device to a gateway.

FIG. 4 is a flow diagram that illustrates an example of a process for a gateway system to create and provide periodic uplink bandwidth allocations for a terminal.

Like reference numbers and designations in the various drawings indicate like elements.

### DETAILED DESCRIPTION

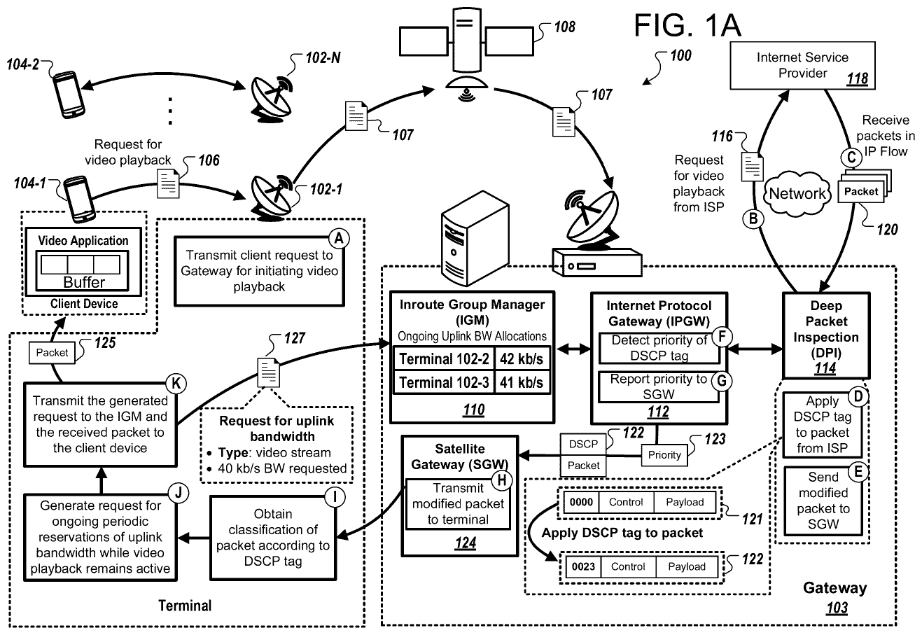

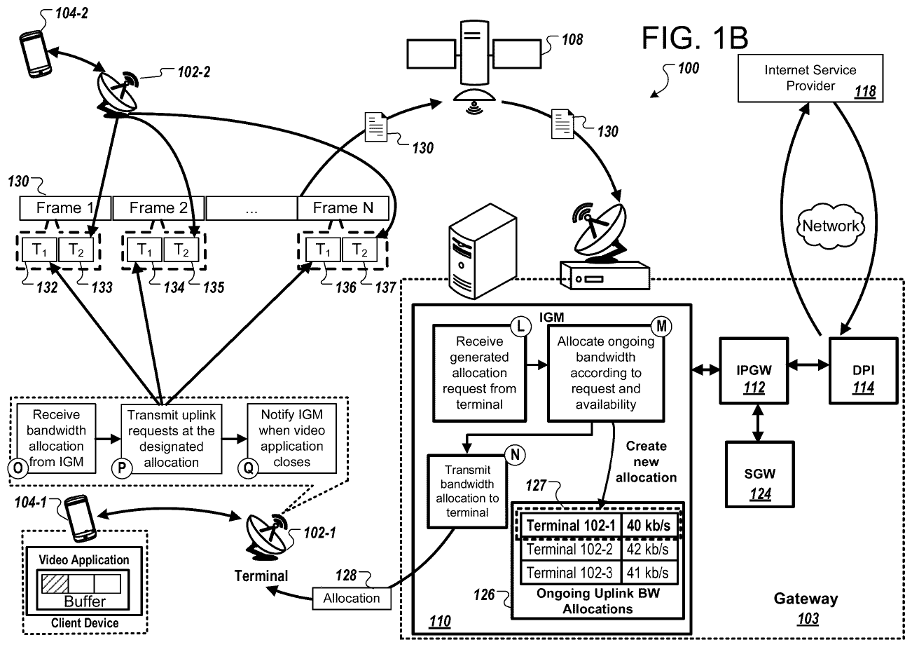

FIG. 1A is a block diagram that illustrates an example of a system 100 for proactively allocating periodic uplink bandwidth for a terminal. The example of FIG. 1A shows a satellite communication system, but the techniques described here can be applicable in other communication systems. The system 100 includes a gateway 103 that communicates with a satellite 108, and the satellite 108 communicates with various satellite terminals 102-1 through 102-N (collectively terminals “102”). The satellite 108 and the gateway 103 (along with other network components) can cooperate to transfer data to and from the terminals 102 to an Internet Service Provider 118 over a network.

Each of the terminals 102-1 through 102-N can be in communication with one or more client devices. The client devices may be known as connected client devices. For example, the connected client devices can include hand-held devices, telephones, laptop computers, desktop computers, Internet of Things (IoT) devices, tables, and so on. The connected client devices communicate with their corresponding terminals over their respective network connections to communicate with the gateway 103 over the satellite 108. FIG. 1A illustrates various operations in stages (A) though (K), which can be performed in the sequence indicated, in another sequence, with additional stages, or fewer stages.

In the example of FIG. 1A, the gateway 103 includes various components configured for different purposes. For instance, the gateway 103 includes an inroute group manager (IGM) 110, an internet protocol gateway (IPGW) 112, a deep packet inspection (DPI) module 114, and a satellite gateway (SGW) 124. In some examples, the IGM 110 can perform a majority of Layer 1 and Layer 2 functionality. In some examples, the gateway 103 may include a demodulator module that can perform the Layer 1 functionality. The Layer 1 functionality includes, for example, symbol reception, bit manipulation, bit synchronization, symbol delivery, and other functions manipulated in the Layer 1 level. The Layer 2 functionality includes, for example, packet reassembly, bandwidth allocation, error-free transmission and reception, frame synchronization, and other functionality manipulated in the Layer 2 level.

In the example of system 100, the devices can communicate using a Multi-Frequency Division Multiple Access (TDMA) communication scheme. In a TDMA communication scheme, terminals 102 can request uplink bandwidth allocations from the IGM 110 of the gateway 103 before transmitting data. The IGM 110 can generate an allocation or multiple allocations of bandwidth for a terminal through an allocation of assignment of multiple slots in the TDMA communication scheme. The IGM 110 (or another component) of the gateway 103 can be responsible for assigning slots in the TDMA communication frame for each of the connected and yet to be connected terminals 102. In some examples, the IGM 110 can assign a slot using a starting slot number and a length of number of slots. In the TDMA communication scheme, the terminals 102 can share the same channel frequency bandwidth. Typically, the amount of bandwidth allocation and the corresponding slots can be updated frequently and often for each frame. The IGM 110 can perform the assignments for a terminal quickly and on a periodic ongoing basis.

In some implementations, the system 100 illustrates that the terminals 102 can communicate to the gateway 103 using a TDMA data structure. The TDMA data structure can be composed of a set of number of N frames. Frames correspond to a standard unit of time period for distributing bandwidth in distinct time slots among the terminals 102. For example, the duration of one frame can be fixed to 45 milliseconds (ms) and each frame is divided into an integral number of slots. In the example of system 100, each slot can be a length of 120 symbols. Ultimately, the IGM 110 can designate the length of each frame and the integral number of slots that compose each frame.

In some implementations, within a particular frame, a terminal, such as terminal 102-1, can insert data to send into their allocated assignment, as designated by the IGM 110. In some cases, a terminal can be allocated slots within the same frame or allocated multiple slots across multiple frames. A frame can be divided into slots, where each slot has a respective length, e.g., 120 symbols for example. However, the frame sizes can also vary, e.g., 192 slots, 384 slots, and so on, based on the designated symbol rate.

The technology of system 100 enables a client device, e.g., client device 104-1, to request for data from the gateway 103 through the terminal 102-1. The client device may launch a particular application, e.g., a video streaming application, and request for the video data from the gateway 103. In some examples, the client device 104-1 may initiate a video streaming application that includes various video streaming protocols. The video streaming protocols enables the video streaming application to request for and download chunks of video data from the internet through the gateway 103.

In some cases, an entire video file is not downloaded from the internet through the gateway 103 in a single request from the terminal 102-1. Rather, the video server may break the video file into smaller segments, e.g., often just a few seconds or more of play time in length. In this example, the client device 104-1 can send a request through the terminal 102-1 to the gateway 103 to download individual segments of the video file. In response, the gateway 103 can provide the individual segments of the video file to the terminal 102-1, which subsequently provides the individual segments to the client device 104-1. In some examples, the client device 104-1 can store the individual segments locally in a buffer for future playback. By storing the individual segments of the video locally in a buffer, the client device 104-1 can ensure the playback buffer for the streaming application is adequately filled, which is essential in minimizing the amount and severity of rebuffering events from the client device's point of view.

In some examples, many streaming services that operate on a client device maintain relatively small video playback buffers. These streaming services include, for example, YouTube™, Amazon Prime Video, TikTok™, and TubiTV™, to name a few examples. When a streaming service includes a relatively small video playback buffer, this requires the streaming service to send requests for frequent video segments in order to ensure that the playback buffer at the client device remains filled, e.g., in order to minimize the amount of rebuffering. However, the latency incurred when a request travels from the terminal 102-1 to the gateway 103 and returning video segments travel back from the gateway 103 to the terminal 102-1 can be quite significant. For instance, the throughput on the forward path, e.g., outroute or gateway 103 to the terminal 102-1 over the satellite communication link, is important in assuring the video segments are downloaded to the client device in a timely manner. Additionally, the latency on the return path, e.g., inroute or terminal 102-1 to gateway 103 over the satellite communication link, is equally as important as the latency and throughput on the forward path. Accordingly, when the terminal 102-1 transmits a request that is delayed, e.g., delay on the return path, the subsequent video segment arrival on the outroute is delayed as well. This incurs additional delays that can significantly disrupt performance at the client device.

In some implementations, the satellite 108 in the system 100 can be geostationary satellites. The geostationary satellites can operate in networks that are particularly susceptible to long latencies. For example, one source of latency in these networks is the radio signal propagation delay to and from the satellite 108, which is typically over 22,000 miles in space. Often, in ideal network conditions, e.g., low latency, high throughput, a one-way delay from a ground component, e.g., terminal 102-1, to the satellite 108 is around 250 milliseconds due to the physical distance of the satellite 108 in space. This problem is also found with low earth orbit satellite networks, but the delay is less due to the distance between the ground components and the satellite 108.

In some cases, the return path from terminals to the gateway system 103 can utilize the TDMA communication system. Under TDMA, the terminals 102 request uplink bandwidth allocations from the IGM 110 before transmitting data to the gateway 103. This process of a terminal submitting an uplink bandwidth request, creation of bandwidth allocation by the gateway 103, and subsequent data transmissions by the terminal can take nearly a second before the request sent by the client device reaches its destination on the Internet over the Internet Service Provider 118. Moreover, delays on the return path are exacerbated even further during periods of satellite network congestion when available bandwidth is limited. Since the inroute bandwidth allocated by the IGM 110 to the terminals 102 is shared amongst many terminals, these additional delays come about during high load as the terminals 102 often compete for the limited inroute bandwidth.

As will be further described below, the IGM 110 can distribute available inroute bandwidth to the terminals 102 using a variety of different rules and algorithms. In some examples, the IGM 110 can utilize a priority-based backlog bandwidth allocation method. In the priority-based backlog bandwidth allocation method, a substantial amount of the bandwidth is allocated for one or more of the requesting terminals 102. With this method, the IGM 110 can consider the total amount of queued data at each terminal 102 along with the relative priority of the data. Considering the bandwidth demands of each of the terminals 102 on the satellite communication network, the IGM 110 can distribute the available uplink bandwidth allocations to respective terminals 102 based on their respective needs.

Accordingly, the system 100 provides techniques that reduces the amount and severity of streaming rebuffering events by prioritizing the streaming traffic. In order to reduce the amount of severity of streaming rebuffering events, the IGM 110 can allocate additional periodic inroute bandwidth in a reservation, and do so on an ongoing basis when a corresponding terminal receives a request from a connected client device that plays a particular configured set of streaming services, which are known to be sensitive to video segment request delays. For instance, and as will be described, the IGM 110 can allocate additional uplink bandwidth on a periodic basis for a particular client device and provide the additional uplink bandwidth to the particular client device regularly and open-ended in time, e.g., every 5 seconds, every 10 seconds, or some other frequency basis. Once the streaming service ceases on the client device or is terminated, the IGM 110 is notified by the terminal 102 and releases the bandwidth allocation for other terminals to utilize.

However, some streaming services that execute on a client device can utilize larger playback buffers and are often more resilient to delays in video requests. Accordingly, such services may not gain much benefit out of additional inroute bandwidth but can still benefit from prioritization of video segment requests and responses using traditional methods, such as weighted fair queuing, for example.

The video segment requests provided by client devices to the corresponding terminal and subsequently to the gateway 103 do not have an easily predictable pacing. In some cases, adaptive streaming protocols may contain complex logic, and the client devices can transmit requests to the gateway 103 through the corresponding terminal based on a variety of factors. These factors include, for example, video resolution, remaining buffer health, and satellite network link capacity. Accordingly, the IGM 110 may have difficulty with providing a corresponding terminal with the additional periodic and automatic uplink bandwidth exactly when the terminals need the uplink bandwidth. Moreover, due to the propagation delay associated with the large geographic distances over the satellite communication link, it is not possible for the terminal to signal to the IGM 110 that a video request has arrived from a connected client device in a timely manner.

For this reason, the IGM 110 can provide the ongoing and periodic uplink bandwidth allocation to the terminals on a consistent and frequent basis. The goal of this periodic bandwidth is to have the uplink bandwidth allocation “ready to go” when the terminal receives a video segment request from a connected client device. Periodic uplink bandwidth, which is allocated to a terminal in-between consecutive video segment requests from a client device, will go to waste if there is not any other user data queued at the corresponding terminal at that point in time.

In some cases, the amount of additional periodic uplink bandwidth chosen by the IGM 110 should be carefully chosen to minimize bandwidth wastage while at the same time providing an adequate support to ensure the video segment requests are transmitted by the terminal quickly upon arrival to the terminal from the connected client device. For instance, the IGM 110 can select an optimal amount of bandwidth, or amount of bandwidth that satisfies a threshold, for the terminal to satisfy these competing constraints. Selecting the optimal amount of bandwidth may vary between different video streaming services and can be configured independently. The IGM 110 may take other factors into consideration, such as the amount of free uplink bandwidth available on the satellite communication network, the number of terminals requesting for uplink bandwidth, and the type of data requested for by the connected client device.

During stage (A), the terminal 102-1 can receive a request 106 from a client device 104-1 to transmit to the gateway 103 for initiating streaming media. For example, client device 104-1 may initiate a streaming application and transmit a request 106 to the terminal 102-1 for streaming data. The request 106 may indicate to the terminal 102-1 that the connected client device 104-1 requests for the streaming data from the gateway 103.

In some implementations, in response to receiving the request 106 from the client device 104-1, the terminal 102-1 can transmit a request 107 to the gateway 103 for the streaming media. The request 107 can include contents related to the purpose of the request. For example, if the terminal 102-1 is not connected to the gateway 103, then the terminal 102-1 can insert a request to set up transmission control protocol (TCP) connections between the terminal 102-1 and the gateway 103 over the satellite 108. If the terminal 102-1 is connected to the gateway 103, then the terminal 102-1 can insert data in the request 107 that indicates a request for initiating streaming media.

The terminal 102-1 can transmit the request 107 to the gateway 103 through the satellite 108. For example, using the TDMA communication scheme, the terminal 102-1 can insert the request 107 into one or more slots of a frame designated by the gateway 103. Similarly, terminal 102-N may transmit a request received from client device 104-2 to the gateway 103 through the satellite 108. Terminal 102-N may insert its corresponding request into one or more slots of another frame designated by the gateway 103. Generally, each terminal, e.g., terminals 102-1 through 102-N, can transmit their request in one or more slots of a frame at its time indicated by the gateway 103. The terminals 102 can modulate the request using a particular modulation scheme, e.g., BPSK, FSK, QPSK, QAM, or other, and transmit the request in the frame at the desired transmit frequency. Given that the terminals 102 are transmitting in the TDMA scheme, each terminal can transmit to the gateway 103 at a different time on the same frequency. In some implementations, the IGM 110 can designate the modulation scheme and the transmit frequency for each of the terminals 102. In some cases, each of the terminals 102 can use a different modulation scheme for the request but they will each transmit on the same transmit frequency.

As the request travels from a corresponding terminal to the satellite 108 and from the satellite 108 to the gateway 103, the IGM 110 may receive each request in the TDMA frame at various times. As mentioned above, the reason for the delay, can be illustrated in system 100 as the variability in the satellite 108's motion and the physical characteristics of the system 100.

During stage (B), the IGM 110 at the gateway 103 can receive and extract the request 107 at one or more slots inserted in the TDMA frame from the terminal 102-1. In some examples, the gateway 103 can downconvert data indicative of the received request 107, demodulate the downconverted data according to the transmitted modulation scheme, perform any decoding on the demodulated bits, and any other processes typically found within a superheterodyne receiver, for example. The gateway 103 can provide the extracted bits from the request 107 to the internet service provider 118 over a network. A deep packet inspection (DPI) module 114 is situated between the internet service provider 118 and the gateway 103. The DPI module 114 inspects or analyzes the extracted bits as they travel to and from the internet service provider 118.

In some examples, the DPI module 114 is a network deep packet inspector that includes one or more techniques to identify video flows using specific signatures. Additionally, the DPI module 114 can identify the type of service provided from the corresponding terminal from the request 107. In some cases, the DPI module 114 can determine classifications of a type of service executing on a connected client device using the flows received from the ISP 118. The DPI module 114 can determine metadata about a flow or session that describes the type of service executing on the connected client device. In some cases, the DPI module 114 can annotate incoming packets with the classifications or metadata about a flow or a session by applying a tag to the packets, adjusting one or more packet header values, or performing another function to the packets.

In some implementations, the DPI module 114 can include a trained machine learning model that is configured to recognize a type of service executing on connected client device that transmitted the request. The trained machine learning model can be configured to recognize the type of service or application that transmitted the request 107 according to various criteria, which includes packet structure, packet header structure, bit flag structures, the protocol utilized in the bit stream, and other data types.

The trained machine learning model can output a number that represents a particular service type, and a statistical confidence that represents how confident the trained machine learning model is in detecting a service type. For example, a value of 1 can represent YouTube™ and a value of 2 can represent TikTok™, to name a few examples. Other values can represent other service types. The statistical values can signal to the DPI module 114 a confidence level that the model is in recognizing a service type. The confidence level may be utilized by the DPI module 114 later after receiving the packets from the Internet Service Provider (ISP) 118.

In some implementations, the gateway 103 communicates with the ISP 118 to retrieve the video segments according to the request 107. The DPI module 114 inspects the packets that flow from the gateway 103 to the internet service provider 118. As illustrated in system 100, the gateway 103 transmits a request 116 to the ISP 118 for the requested streaming segments according to the request 107. The request 116 may include, for example, the contents of the request 107, such as the bits or bytes in a frame structure that represents the streaming segments that the client device 104-1 requests for viewing.

During stage (C), in response to the gateway 103 providing the request 116 to the ISP 118, the ISP 118 can provide an internet protocol flow of streaming media back to the gateway 103. The DPI module 118 can inspect the packets that flow from the internet service provider 118 to the gateway 103. The internet protocol flow may include a continuous flow of TCP traffic or a flow of packets between the ISP 118 and the gateway 103 through the DPI module 114. The internet protocol flow or flow of packets can communicate streaming media, which includes one or more packets 120. The one or more packets 120 of the streaming media may be, for example, video packets, audio packets, and other streaming media data types. The packets 120 can be formatted in manner that is viewable and playable by the corresponding streaming service on the connected client device that transmitted the request 106. As the packets flow from the ISP 118 to the gateway 103, the DPI module 114 can inspect the packets and determine the streaming service to which the one or more packets 120 are directed towards.

During stage (D), the DPI module 114 can determine the streaming service to which the streaming media are directed towards. In some examples, the DPI module 114's trained machine learning model can identify the streaming service executing on the connected client device that transmitted the request 107 by analyzing the one or more packets 120 of the streaming media. Specifically, the DPI module 114 can provide, as input to the trained machine learning model, a portion of the one or more packets 120, e.g., their headers, or the one or more packets 120 themselves. The trained machine learning model can be configured to identify the service type according to the destination of the one or more packets 120, the protocols utilized in the one or more packets 120, the data included in the packets 120, and data included in the headers of the packets 120. Similar to stage (B), the trained machine learning model can output a number that represents a particular service type, and a statistical confidence that represents how confident the trained machine learning model is in detecting a service type.

The DPI module 114 may compare the machine learning model outputs between stages (B), e.g., output from the trained machine learning model analyzing data extracted from the request 107 and (D), e.g., output from the trained machine learning model analyzing data in the packets 120. If the two outputs are similar, then the DPI module 114 does not need to perform any further analysis. However, if the two outputs are different, then the DPI module 114 can analyze the statistical confidences corresponding to each output to determine which service type is more likely. For example, if the output of the trained machine learning model in stage (B) is 0 and 25% confidence, and the output of the trained machine learning model in stage (D) is 1 and 85% confidence, then the DPI module 114 can select the latter output with the service type as 1 and disregard the former output. In some cases, the DPI module 114 can retrain the trained machine learning model using the output in stage (D) if the outputs of the trained machine learning model differ between stages (D) and (B).

In some implementations, the DPI module 114 can apply a value indicative of the determined service type to the one or more packets 120 of the streaming media in response to determining the service type of the streaming media. In some examples, the value can be a flag, a bit mask, another data packet, or another data type. For example, the value can be a Differentiated Services Code Point (DSCP), which is a value included in the field of each of the one or more packets 120 of the streaming media.

The value indicative of the determined service type can be a number that represents the service type. For example, a value of 21 can represent YouTube™, a value of 22 can represent TikTok™, and a value of 23 can represent TubiTV™, to name some examples. Other examples are also possible. In some cases, the DPI module 114 can insert the value associated with the determined service type in a seven-bit field in the one or more packets 120. For example, as illustrated in system 100, the DPI module 114 includes a particular packet 121 selected from the one or more packets 120. The particular packet 121 includes a number of header bits, a number of control bits, and a payload. The DPI module 114 can apply the DSCP tag associated with the determined service type to the number of header bits. For example, the DPI module 114 changes the value of the header bits to 23, associated with the determined service type, e.g., TubiTV™. The DPI module 114 applies the DSCP tag using, for example, bit masking, XOR'ing, and summation between the values of the header and the bit representation version of the header. The modified packet 122 now includes the proper header values to signal to the terminal that transmitted the request 102-1 that the periodic uplink bandwidth allocations are required. The DPI module 114 can apply this process to each packet of the streaming media. This process will be further described below.

During stage (E), the gateway 103 can transmit the modified packets 122 of the streaming media to the IPGW 112 and subsequently to the satellite gateway (SGW) 124. In some implementations, the gateway 103 can provide the modified packets 122 from streaming media to the IPGW 112 after the DSCP tag has been incorporated in the modified packets 122 by the DPI module 114. In some cases, the gateway 103 can store the modified packets 122 in memory and send the modified packets 122 location, e.g., as a pointer, in memory to the IPGW 112.

During stage (F), the IPGW 112 can obtain the modified packets 122 from the gateway 103. In response to obtaining the modified packets 122, the IPGW 112 can determine a priority level of the modified packets 122. The IPGW 112 uses the determined priority level of the modified packets 122 to determine an estimated amount of demand across the terminals 102. The IPGW 112 aggregates the estimated amount of demand on a per priority basis and reports the estimated amount of demand to the SGW 124. The SGW 124 can determine an amount of outroute or forward path bandwidth to allocate for transmitting the modified packets 122 to the corresponding terminal.

The IPGW 112 can classify the packets to various number of priorities. The priorities include, for example, interactive priority, streaming priority, bulk priority, and conversational priority. Other examples are also possible. Interactive priority represents services that involve user interaction, such as chatrooms, video calls, browsing an application, and services that require the user to select and interact with the streaming service. Streaming priority represents services that involve streaming video, streaming audio, or streaming other forms of media to the connected client device. Bulk priority represents services that involve downloading a file or transferring a file to the connected client device. This can include, for example, downloading a large video, a high-resolution image, or a high-resolution song. The conversational priority represents services mainly for voice calls over telephone or other types of services.

The IPGW 112 classifies the packets into these various priorities based on their latency sensitivity. Generally, the IPGW 112 classifies the packets into one of the priorities to properly allocate bandwidth based on their latency sensitivity. Certain priorities, such as conversational priority, streaming priority, and bulk priority, require more bandwidth than the other priorities. For example, conversational priority requires bandwidth be allocated without delay due to the voice call degradation if bandwidth is unavailable. Similarly, streaming priority requires bandwidth allocation with minimal delay because the streaming service needs to provide a continuous stream of data to the connected client device to maintain a desirable user experience. Bulk priority, on the other hand, does not need immediate bandwidth allocated because a large file that is downloaded or transferred will incur some delay. Accordingly, the IPGW 112 can classify these services into one of the priority types in order to ensure proper bandwidth allocation and minimal delay is incurred at the connected client device.

In some cases, the IPGW 112 can respond to the server, e.g., gateway 103, on behalf of the client, known as “spoofing”, TCP traffic. Spoofing a packet can cause some of the headers to change, with the DSCP header being one of them. In some cases, the IPGW 112 does not touch or change the DSCP flag so that a corresponding terminal the packet was meant for can receive and interpret the DSCP flag. Here, the IPGW 112 maintained the original DSCP flag that was received to signal to the user's terminal that a video has started. Accordingly, the IPGW 112 spoofed the TCP traffic received from the gateway 103 and modified by the DPI module 114 but did not change the DSCP header.

In some implementations, the IPGW 112 can classify the packets according to the DSCP tag value included in the header of the packets. For example, the IPGW 112 can inspect the DSCP tag value in the header to be 23 and associate the packet with a priority of streaming. Other examples are also possible. The IPGW 112 can inspect packets from each of the terminals 102 and aggregate the demand across all the terminals 102. For example, the IPGW 112 may determine that terminal 102-1 and terminal 102-2 request for data that have been classified under the streaming priority and terminal 102-3 requests for data under the bulk priority. The IPGW 112 can aggregate the demand per priority and report the aggregated demand.

In some cases, the IPGW 112 can aggregate demand per priority by assigning a value for each request. Continuing with the above example, the IPGW 112 can assign a value of 2 for the streaming priority and a value of 1 for the bulk priority. Other examples are also possible.

In some cases, the IPGW 112 can assign a bandwidth amount for the aggregated demand per priority. For instance, for the outroute bandwidth of the streaming priority, the IPGW 112 typically allocates 50 kilobits (kbits)/sec of BW to provide to a respective terminal. If the IPGW 112 determines that two terminals request for data of the streaming priority type, then the IPGW 112 determines that 100 kbits/sec of BW is needed in total across the two terminals. Similarly, for the outroute bandwidth of the bulk priority, the IPGW 112 typically allocates 100 kbits/sec of BW to provide to a respective terminal. Accordingly, the IPGW 112 can determine that 100 kbits/sec of BW is needed for the streaming priority and 100 kbits/sec of BW is needed for the bulk priority.

During stage (G), the IPGW 112 reports the aggregated demand per priority and the modified packets 122 to the SGW 112. Generally, the IPGW 112 can provide, for each terminal that provided a request to the gateway 103, the modified packets and the associated determined aggregated demand for those packets to the SGW 112. For example, the IPGW 112 transmits the modified packets 122 and the aggregated demand of 100 kbits/sec for the bulk priority to the SGW 112.

During stage (H), the SGW 124 can receive the modified packets 122 and the aggregated demand for the particular terminal. In response, the SGW 124 can determine an outroute allocation for that terminal based on the determined aggregated demand and the overall availability of bandwidth in the system 100. Then, the SGW 124 can transmit the modified packets 122 to the corresponding terminal using the outroute bandwidth allocation. The outroute bandwidth allocation represents the downlink bandwidth allocation for the SGW 124 to transfer data to a particular terminal.

In some examples, the SGW 124 can determine an outroute bandwidth for transmitting the modified packets 122. The SGW 124 can determine the total amount of available outroute bandwidth for the network, and the total amount of currently utilized outroute bandwidth for the network. For example, if the total amount of outroute bandwidth is 500 kbits/sec of BW and the total amount of currently utilized outroute bandwidth for the network is 200 kbits/sec, then the SGW 124 determines a total of 300 kilobits/sec of BW is currently available to utilize across all terminals 102 in the system 100.

In some implementations, the SGW 124 can apply one or more algorithms to determine am amount of allocated bandwidth to designate for each terminal on the outroute based on the total amount of available bandwidth and the aggregated demand per priority. For example, the SGW 124 determines the total amount of bandwidth is 300 kbits/sec, the aggregate demand for the bulk priority is 100 kbits/sec, and the aggregate demand for the streaming priority is 50 kbits/sec. Moreover, the SGW 124 can determine that terminal 102-1 and terminal 102-2, both requesting for data that was classified as the streaming priority, are each to be allocated with 50 kbits/sec of BW, for a total of 100 kbits/sec. Additionally, the SGW 124 can determine that terminal 102-3, which requests for data that was classified as the bulking priority, is to be allocated with 100 kbits/sec of BW.

In this manner, the SGW 124 ensures that each terminal, e.g., 102-1 through 102-3, is assigned outroute bandwidth based on their respective priority and that a sufficient amount of bandwidth remains available should the gateway 103 receive any future requests. For example, 200 kbits/sec of BW are now allocated to the terminals 102-1 through 102-3 with 100 kbits/sec of BW available for any future requests from the terminals 102. In other examples, the SGW 124 can allocate outroute bandwidth for a respective terminal using other factors or algorithms, such as averaging, weighting, and other algorithms.

In response, the SGW 124 can transmit the modified packets 122 of the streaming media to the respective terminal in one or more codeblocks of the allocated outroute bandwidth for that respective terminal. For example, the SGW 124 can transmit the modified packets 122 of the streaming media to terminal 102-1 in one or more codeblocks of a frame in the 50 kbits/sec of BW allocated to terminal 102-1. The SGW 124 can transmit the modified packets 122 to the terminal 102 over the satellite 108. Similarly, the SGW 124 can transmit modified packets to the other respective terminals in one or more codeblocks of a frame for the allocated outroute bandwidth for the other respective terminals.

In some implementations, the SGW 124 can transmit the modified packets 122 to terminal 102-1 in one or more codeblocks of a communication frame over time. As mentioned, the ISP service provider 118 may provide the packets 120 as a continuous streaming media in an internet protocol flow. As the DPI module 114 receives the continuous streaming media from the ISP 118, the gateway 103 can perform processes (D) through (H) on a continuous basis. In some cases, the gateway 103 can continue to provide the streaming media from the ISP 118 even as the gateway 103 streams the periodic uplink bandwidth allocations to the terminal 102-1 over the satellite 108.

During stage (I), the terminal 102-1 can receive the flow of packets that includes the streaming media with the modified packets 122 over the satellite 108 from the SGW 124. As mentioned, the flow of packets includes the TCP communication traffic over the satellite 108. In response to receiving the flow of packets, the terminal 102-1 can determine from inspecting the headers of the modified packets 122 in the streaming media whether these packets correspond to a request provided for streaming data. If the terminal 102-1 determines the headers internet protocol flow includes a classification, e.g., DSCP tag, then, the terminal 102-1 can determine the classification of the packets or a classification of the type of streaming media. For example, the terminal 102-1 may determine that the DSCP tag included in the packets corresponds to a value of 23. In some cases, the terminal 102-1 can determine from the value of the DSCP tag the particular application executing on the connected client device. For example, the terminal 102-1 can determine that the DSCP tag value of 23 corresponds to the executed application of TubiTV™. By identifying the DSCP tag in the modified packets 122, the terminal 102-1 identifies the arrival of streaming data requested for by the client device 104-1.

In some implementations, each terminal may include a classifier that is trained to analyze the internet protocol flow. The classifier can be configured to output data that represents the internet protocol flow related to the streaming media. For example, the local classifier can be trained to detect, at least one of, (i) the classification for the internet protocol flow related to the streaming media, (ii) detection of streaming video related to the streaming media, and (iii) a type of service utilized at the connected client device for the streaming media. The classification for the internet protocol related to the streaming media can include, for example, an indication that the analyzed internet protocol flow includes or does not include streaming media. The detection of streaming video related to the streaming media can include, for example, an indication of whether the streaming media relates to streaming video or not. Additionally, the type of service utilized at the connected client device for the streaming media can include, for example, an application service used at the client device for the streaming media, such as, YouTube™, Amazon Prime Video, TikTok™, and TubiTV™, to name a few examples. Other examples are also possible. The terminal 102-1 can utilize the classifier in addition to inspecting the DSCP tag of the internet protocol flow received from the gateway 103.

During stage (J), the terminal 102-1 can generate a request to transmit to the gateway 103 for a reservation of periodic uplink bandwidth allocations for the client device's streaming service for future communication frames. The terminal 102-1 can generate the request to include, for example, an indication that a reservation of periodic uplink bandwidth allocations is requested for the particular terminal, a requested amount of uplink bandwidth, and the type of streaming service being utilized for this uplink, to name some examples. In some examples, the terminal 102-1 may include the frequency with how often the gateway 103 should transmit the periodic bandwidth allocation, e.g., every 4 seconds, 5 seconds, or other. The terminal 102-1 may also include other information in the request, such as an address for the client device requesting the data and timestamp for when the terminal 102-1 received the modified packets 122. The terminal's request is also sent to the gateway 103 and requested for while the streaming media to the connected client device 104-1 remains active.

In some implementations, the terminal 102-1 may determine an amount of uplink bandwidth allocation to request using data stored in profiles. Each terminal may store profiles according to a service type, a client device, an application type, and a user associated with a client device, to name a few examples. The terminal 102-1 can select one or more profiles when determining how much uplink bandwidth allocation to request from the gateway 103. In some examples, the terminal 102-1 can select a profile from each of the service type, the client device, the application type, and the user, and retrieve an amount of uplink bandwidth from each of the profiles. The terminal 102-1 may select the amount of uplink bandwidth allocation to request for by, for example, averaging the bandwidths selected from each profile, selecting the bandwidth that appears more frequently than others, or another method for selecting the uplink bandwidth allocation.

For the service type, a terminal can store the type of service or priority, e.g., streaming, bulk, conversational, and interactive, an amount of bandwidth recommended to be requested for each service, e.g., 40 kbits/sec, 50 kbits/sec, or other, and a history of bandwidth requested from the gateway for each service. The terminal can determine the amount of bandwidth to request for the service type using the amount of bandwidth recommended and the history of bandwidth requested from the gateway.

For the client device, a terminal can store data that identifies the client device, e.g., an IP or MAC address of the client device, a type of the client device, e.g., laptop, mobile device, tablet, personal computer, smart watch, or other, and hardware characteristics of the client device, e.g., processor type, memory size, number of applications stored on client device, etc. The terminal may include a profile for each different client device, and a profile for each client device type and their respective characteristics. Moreover, each profile for the client device can include the amount of uplink bandwidth allocation previously requested for by this type of client device. In this manner, the terminal 102-1 can retrieve a profile for the device type associated with the client device that transmitted request 106, e.g., client device 104-1, and select the amount of uplink bandwidth allocation previously requested for to send to the gateway 103.

For the application type, a terminal can store a profile for each particular application utilized on a connected client device. The profile can include, for example, data that identifies the particular application, characteristics of the application, and for that particular application, the amount of uplink bandwidth allocation previously requested for when a client device is executing this application. The terminal 102-1 can select the profile for each particular application utilized on a connected client device when the terminal 102-1 extracts the DSCP tag from the header of the modified packets 122. The terminal 102-1 can convert the DSCP tag into data that identifies the particular application, e.g., the number 23 represents TubiTV™, and select, as an index, the profile corresponding to the particular application. The terminal 102-1 can identify the previously requested bandwidth amount from the corresponding profile.

For the user associated with a client device, a terminal can store a profile for each user that uses a connected client device. When a user launches an application on a client device, the user authenticates access to using the application by providing a username/email and password. These login credentials can identify the user. Often, the login credentials are passed from the connected client device to the corresponding terminal. The terminal can store these login credentials in a respective profile, and associate previously requested uplink bandwidth allocations with the particular login credentials. The profile may also include, for example, applications utilized by the particular user, client device types utilized by the particular user, and other information pertinent to the user. The terminal 102-1 can identify the previously requested bandwidth amount from the corresponding profile for the particular login credentials associated with the user for client device 104-1.

In some implementations, the terminal 102-1 can select an amount of uplink bandwidth allocation to request for from the gateway 103 using one or more identified profiles. As specified, the terminal 102-1 may, for example, average the amount of uplink bandwidth allocations from each of the selected profiles, select the median amount of uplink bandwidth allocation from each of the selected profiles, or randomly select an uplink bandwidth allocation, to name a few examples. The selected uplink bandwidth allocation can be inserted into the request to transmit to the gateway 103.

In some implementations, the terminal 102-1 can include data that represents how often the terminal 102-1 requests for periodic uplink allocations from the gateway 103. For instance, the terminal 102-1 may request the uplink bandwidth allocations be provided on a periodic basis such as, every 3 seconds, every 4 seconds, or another periodic basis. The terminal 102-1 may determine the frequency at which the requests be provided based on how frequent previous uplink bandwidth allocations were received, a roundtrip time between the terminal and the gateway over the satellite, and size of the buffer in the application on the connected client device, to name a few examples. For example, if the roundtrip time between the terminal and the gateway is high, the terminal may request more uplink bandwidth allocations on a more frequent basis, e.g., every 3 seconds, to account for the high latency. Similarly, if the size of the buffer utilized in the application on the connected client device that is playing the streaming media is small, then the terminal can request for uplink bandwidth allocations on a more frequent basis, e.g., every 2 seconds, to reduce the amount of rebuffering and latency that may occur due to small buffer sizes. Alternatively, if the buffer size is large, or the round-trip time between the terminal and the gateway is low, then the terminal may request uplink bandwidth allocations on a less frequent basis, e.g., every 10 seconds, and allow the gateway 103 to focus bandwidth resources for other terminals.

Thus, the terminal 102-1 can include the requested amount of bandwidth, the type of streaming service requesting for data, and in some cases, the frequency with which the uplink bandwidth allocations are requested from the gateway 103. In some cases, the request 127 can be generated as a data packet, a message, or another data type. The terminal 102-1 can modulate the data of the request 127 using a designated modulation scheme and prepare the data to be transmitted at particular transmit frequency.

During stage (K), the terminal 102-1 can transmit the generated request 127 to the IGM 110 over the satellite 108 over a communication frame, e.g., TDMA frame. As shown in system 100, the request 127 includes video stream as the type of streaming application and 40 kbits/sec of BW requested for the periodic and ongoing uplink bandwidth allocations. Here, the terminal 102-1 transmits the request in order to maintain at least a minimum allocation of uplink bandwidth while the streaming application on the client device remains active. Other examples for the request 127 are also possible. Additionally, the terminal 102-1 can transmit the one or more modified packets 122 to the connected client device 104-1. The connected client device 104-1 can store the modified packets 122 in the buffer of the streaming application and execute or read the data from the modified packets 122 stored in the buffer to play on the connected client device.

FIG. 1B is a block diagram that illustrates an example of a system 100 for proactively allocating periodic uplink bandwidth for a terminal. In some implementations, the processes illustrated in FIG. 1B includes processes that continue from FIG. 1A. FIG. 1B illustrates various operations in stages (L) through (Q), which can be performed in the sequence indicated, in another sequence, with additional stages, or with fewer stages.

During stage (L), the IGM 110 can receive the generated request 127 for the periodic and ongoing uplink bandwidth allocation from the terminal 102-1 over the satellite 108. As mentioned, the request 127 can include a request for a reservation of periodic uplink bandwidth allocation, the type of the streaming application on the connected client device and an amount of bandwidth for each periodic uplink allocation. In some cases, the request 127 can include the frequency with which the repeated allocations of uplink bandwidth are received over time from the gateway 103. In this manner, the terminal 102-1 can ensure that a consistent amount of uplink bandwidth is available over time, with no end time specified.

In some implementations, the IGM 110 may receive multiple requests from the terminals 102 for the periodic and ongoing uplink bandwidth allocations. For instance, terminal 102-1 may send two requests for the periodic and ongoing uplink bandwidth allocation. This may be the case when the terminal 102-1 is servicing a client device 104-1 and a different client device 104-2. Both of these client devices may have different uplink bandwidth allocation requests for different streaming services.

Accordingly, the terminal 102-1 may provide multiple requests, each request for a different client device. For example, the IGM 110 may receive two uplink bandwidth allocation requests from terminal 102-1, one uplink bandwidth allocation request from terminal 102-2, and two uplink bandwidth allocation requests from terminal 102-3. Other examples are also possible. In the case where the IGM 110 receives multiple requests for uplink bandwidth allocation from one or more terminals, the IGM 110 can determine an amount of uplink bandwidth to allocate for each terminal and create periodic bandwidth allocations for each terminal's request.

During stage (M), the IGM 110 can generate a reservation that allocates ongoing uplink bandwidth allocations according to the request provided by a respective terminal and the amount of uplink network availability. The request provided by the terminal to the IGM 110 signals or indicates to the IGM 110 for a reservation that allocates an amount of periodic uplink bandwidth in an ongoing manner irrespective of whether the terminal asks for the periodic uplink bandwidth or not.

The IGM 110 can create the reservation that includes allocations that are made without specific requests. The IGM 110 can create the allocations independent of a transmission queue or an amount of data pending to be sent by the connected client device. Moreover, the IGM 110's creation of the allocations continues regardless of a current demand until a termination event. The termination event include, for example, a client device's finishing screen, the client device closing the application or timing out, and the IGM 110 determining the uplink bandwidth has run out. Running out of uplink bandwidth in the network can include a lack of bandwidth that is unable to be utilized elsewhere.

The IGM 110 can create the reservation of periodic uplink bandwidth for that particular terminal on an indefinite basis. The reservation can include an amount of uplink bandwidth allocated for the particular terminal, the frequency with which the IGM 110 is to provide the uplink bandwidth allocation to the particular terminal, and data describing the video service associated with the particular terminal. The IGM 110 can cease or terminate the reservation in response to receiving an indication from the terminal that the reservation is no longer required, e.g., the streaming application on the corresponding connected client device has stopped.

In some implementations, the IGM 110 can maintain a table 126 of ongoing reservations or ongoing and periodic uplink bandwidth allocations. The table 126 can specify the current reservations created for the terminals 102. In some cases, the table 126 can include one or more reservations for a respective terminal. More than one reservation may be created for a particular terminal when a terminal services two or more client devices, each servicing for a respective client device. Alternatively, more than one reservation may be created for a particular terminal when a terminal services a single client device that is executing multiple streaming services at the same time. However, the IGM 110 may not create more reservations than the total amount of bandwidth in the network of system 100 or the total unused bandwidth in the network of system 100.

In some implementations, the IGM 110 can store specific information for each reservation in the table 126. The specific information for each reservation can include, for example, data identifying the terminal that requested the reservation, the amount of uplink bandwidth allocated for that reservation, the type of service the reservation is servicing, and the periodicity or frequency with which to provide the uplink bandwidth allocation. The table 126 may store an available amount of network bandwidth to create additional reservations, a total amount of network bandwidth currently utilized, and a total amount of network bandwidth offered by system 100. The IGM 110 can utilize these statistics to make determinations about, for example, whether new reservations can be created and whether current reservations need to be cancelled.

In some cases, the IGM 110 can analyze the statistics in the table 126 to determine whether the request provided by the terminal can be satisfied. For example, the IGM 110 can determine that terminal 102-1 requests for an ongoing uplink bandwidth allocation of 40 kbits/sec of bandwidth for a video streaming service. The IGM 110 can first determine whether the requested amount of bandwidth is available for the terminal 102-1. The statistics stored in the table 126, and specifically, the available amount of network bandwidth to create additional reservations, the total amount of network bandwidth currently utilized, and the total amount of network bandwidth offered by system 100, can signal to the IGM 110 whether the requested amount of bandwidth is available for terminal 102-1. If the IGM 110 determines that the uplink bandwidth allocation request can be satisfied, then the IGM 110 can create the reservation for that terminal.

However, in some cases, the IGM 110 may use predictive analytics to determine whether the terminal 102-1's request can be satisfied. For example, the IGM 110 may receive the request from terminal 102-1 for a reservation of 40 kbits/sec of bandwidth. However, the IGM 110 can use various methods, e.g., heuristics, machine learning models, and other prediction tools, which can determine when other terminals transmit requests for reservations. Using the prediction tools, the IGM 110 may learn over time that terminal 102-2 requests for 80 kbits/sec of bandwidth every Wednesday at 9 AM for video streaming and terminal 102-3 requests for 80 kbits/sec of bandwidth every Wednesday at 10 AM for video streaming. Continuing with this example, if the IGM 110 receives a request from terminal 102-1 at 8 AM on Wednesday for 100 kbits/sec of bandwidth for a lower priority service, and the total available bandwidth is 170 kbits/sec, then the IGM 110 may deny the terminal 102-1's request because the IGM 110 can predict that terminals 102-2 and 102-3 will request for a total 160 kbits/sec by 10 AM. These upcoming requests will leave only a total of 10 kbits/sec for other services, and accordingly, the IGM 110 will be unable to fill the request from terminal 102-1. Other examples are also possible.

However, in the chance that the IGM 110's prediction tools are inaccurate, and the IGM 110 does not receive reservation requests from terminals 102-2 and 102-3 by 10 AM on Wednesday, then the IGM 110 can fulfill the next request that comes in from another terminal. Assuming the next request's bandwidth reservation is below the 160 kbits/sec total available bandwidth. Additionally, the IGM 110 can retrain the predicted tools by providing feedback data indicating that the terminals 102-2 and 102-3 did not request for uplink bandwidth reservations as previously predicted.

If the IGM 110 determines that the request from terminal 102-1 can be fulfilled, the IGM 110 can create a new reservation 127 in table 126. The new reservation 127 can be added as another row in the table 126. The IGM 110 can insert in the row the specific information for the new reservation 127.

As mentioned above, the specific information can include, for example, data identifying the terminal that requested the reservation, the amount of uplink bandwidth allocated for that bandwidth, the type of service the reservation is servicing, and the periodicity or frequency with which to provide the uplink bandwidth allocation. In this example, the data identifying the terminal that requested the reservation can include a name for the terminal, an IP or MAC address of the terminal, or other data identifying the terminal. The amount of uplink bandwidth allocated for that bandwidth can include 40 kbits/sec, for example. The type of service the reservation is servicing can include, for example, a video streaming service. The periodicity or frequency with which to provide the uplink bandwidth allocation can include, for example, a timer or an interrupt service that specifies how often the bandwidth allocation is to be provided or delivered to the terminal. For example, the timer or the interrupt service may operate every 5 seconds, 10 seconds, 20 seconds, or other. The amount of time operated for the timer, or the interrupt service may be based on the amount of time requested for in the request provided by the terminal, the availability of the IGM 110 to deliver the uplink bandwidth allocation to the terminal when the timer elapses or the interrupt service triggers, to name some examples. This information may be stored in the table 126 and analyzed by the IGM 110 periodically.

In some implementations, the IGM 110 may periodically analyze the table 126 to determine when to deliver the uplink bandwidth allocation to the corresponding terminal. For example, the IGM 110 may operate in a multi-threaded environment-one thread handling the received requests from the terminals, another thread handling the processes of monitoring the periodicity with which to provision the uplink bandwidth allocations according to the data stored in the table 126, and another thread that does the actual provisioning of uplink bandwidth allocation to the corresponding terminal at the designated time. Other threads and corresponding functions for the IGM 110 to perform are also possible.

During stage (N), the IGM 110 can transmit an uplink bandwidth allocation to a corresponding terminal. For example, as illustrated in system 100, the IGM 110 can select row 127 from table 126 when the corresponding timer, interrupt service, or other function, triggers, which indicates the provisioning of uplink bandwidth allocation. In response to the timer triggering, the IGM 110 can select, from the row 127, the terminal to which to provide the uplink allocated bandwidth, e.g., terminal 102-1, and the amount of allocated uplink bandwidth, e.g., 40 kbits/sec. The IGM 110 can transmit the allocated uplink bandwidth 128 to the terminal 102-1 over the satellite 108. After transmitting the allocated uplink bandwidth 128 to the terminal 102-1, the IGM 110 can restart the timer or interrupt service for that respective reservation 127 to ensure the provisioning of uplink bandwidth allocation continues without the terminal 102-1 asking for additional uplink bandwidth. The IGM 110 can perform this process for each reservation in the table 126 each time an uplink bandwidth allocation is to be provisioned to a corresponding terminal.

During stage (O), the terminal 102-1 can receive the allocation 128 of uplink bandwidth from the IGM 110. The allocation 128 can include a timing and an amount of bandwidth that the terminal 102-1 can utilize for transmitting a request for additional streaming data in one or more TDMA frames. This allocation 128 is provided by the IGM 110 on a periodic and ongoing basis so that the terminal 102-1 does not need to request for an uplink bandwidth allocation. Instead, the terminal 102-1 can utilize the uplink bandwidth on an as-needed basis. If the terminal 102-1 does not need the uplink bandwidth when the IGM provisions the periodic bandwidth, then the terminal 102-1 can discard the uplink bandwidth allocation 128 and wait for the next uplink bandwidth allocation from the IGM 110.

In some implementations, the terminal 102-1 can hold onto the provisioned uplink bandwidth allocation 128 for a predetermined amount of time. The provisioned uplink bandwidth allocation 128 can specify a time at which the terminal 102-1 can insert a request for subsequent data from the connected client device 104-1 into one or more TDMA frames. If the terminal 102-1 did not insert the request for subsequent data into the TDMA frames at the corresponding time, that means the terminal 102-1 determines there is no demand from the client device 104-1 for subsequent data or the terminal 102-1 did not receive a request from the client device 104-1 for subsequent data.

If the terminal 102-1 receives a request for subsequent data from the client device 104-1 and the terminal 102-1 has not yet received the uplink bandwidth allocation 128, then the terminal 102-1 waits to receive the uplink bandwidth allocation 128 from the IGM 110. The periodicity at which the bandwidth allocation request is provisioned from the IGM 110 to the terminal 102-1 is minimal, so the terminal 102-1 will not wait long before receiving the next uplink bandwidth allocation request. Once the terminal 102-1 receives the next uplink bandwidth allocation request from the IGM 110, the terminal 102-1 can insert the connected client device 104-1's request for subsequent data into one or more TDMA frames at the specified time indicated by the allocation 128.

By provisioning the periodic uplink bandwidth allocations on a periodic basis, the terminal 102-1 can attempt to prevent or minimize any buffering delay in the application at the connected client device 104-1. For example, the application operating on the client device 104-1 may include a buffer that stores the data from the modified packets 122 provided by the SGW 124 of the gateway 103. The application can read data out of the buffer to play, e.g., such as reading video data out of the buffer and playing the video. When the buffer is empty or near empty, the application may trigger a request to be sent to the terminal 102-1 to request for additional data. If the terminal 102-1 has to send a request to the gateway 103 over the satellite 108 for an uplink bandwidth allocation, then further delays are incurred at the client device 102-1.

However, if the uplink bandwidth allocation request is already provided to the terminal 102-1 before the application at the client device 104-1 requests for additional data or the terminal 102-1 does not need to request for the uplink bandwidth allocation because the gateway 103 is providing the uplink bandwidth allocation on a periodic basis, then delays can be significantly reduced. Here, a goal of system 100 is to ensure the buffer in the application on the client device 104-1 is adequately filled to minimize the amount and severity of rebuffering events. By allocating and provisioning an ongoing and continuous uplink bandwidth allocation, the goal can be achieved, as the gateway 103, the terminal 102-1, and the client device 104-1 can work collectively to ensure the buffer remains filled with the additional periodic uplink bandwidth. The additional periodic uplink bandwidth allocation reduces the time requests travel from the client device 104-1 to the ISP 118, and back.

During stage (P), the terminal 102-1 can transmit requests from the client device 104-1 at the timing indicated by the uplink allocation 128. The terminal 102-1 can insert data from the client device 104-1's request into the TDMA data structure 130. The terminal 102-1 can insert data of the client device 104-1's request into the one or more slots of a TDMA frame or into one or more slots across multiple TDMA frames. As illustrated in system 100, the terminal 102-1 can insert data of the client device 104-1's request into slot 132 of frame 1 indicated by T₁. In some examples, the terminal 102-1 may indicate that other slots can be used, such as a slot 134 of frame 2 indicated by T₁, and a slot 136 of frame N indicated by T₁.

In some implementations, the other terminals can insert data of their respective client device's request into other slots of the TDMA data structure 130. For example, terminal 102-2 may insert data of the connected client device 104-2's request into one or more slots of a TDMA frame or into one or more slots across multiple TDMA frames. The terminal 102-2 inserts into the connected client device 104-2's request into slots in the TDMA data structure 130 according to an allocation provided by the IGM 110. The slots for terminal 102-2 are different from the slots for terminal 102-1 so there are no collisions of data that make interpreting the data requests undiscernible by the IGM 110. In this manner, multiple terminals can submit their data requests in respective data slots of a TDMA frame according to allocations provided by the IGM 110.

If the terminal 102-1 does not have data to insert in the slot indicated by the allocation 128, then the slot is not used. However, the other terminals may still use the allocated slots. Although the bandwidth of the allocated slot in the TDMA frame will not be used, the bandwidth is available for the particular terminal irrespective of whether the particular terminal needs the bandwidth or not.

In response to inserting the data into their respective slots, the terminals 102 can transmit the TDMA data structure 130 to the gateway 103 through the satellite 108. As mentioned, each terminal can transmit the data in the allocated slot to the gateway 103 at the respective time as indicated by the allocation 128. The terminals 102 can modulate the data in the TDMA frame using a particular modulation scheme, e.g., BPSK, FSK, QPSK, QAM, and transmit the data in the TDMA frame at the desired transmit frequency. Because each terminal transmits the data in the TDMA scheme, each terminal can transmit at a different time in the slot indicated at the same frequency. In some cases, the IGM 110 can designate the modulation scheme and the transmit frequency for each terminal.

The IGM 110 can receive the request from the terminals in the TDMA scheme and forward the request to the ISP 118. The process then continues using functions similar to stages (B)-(K), where the SGW 124 provides the modified packets 122 to the client device 104-1. However, because the IGM 110 has already received the request 127 from the terminal 102-1 for the allocated uplink bandwidth, the terminal 102-1 does not send another request for the allocated uplink bandwidth. Instead, the terminal 102-1 waits for another subsequent data request from the client device 104-1. At the same time, the IGM 110 provides the uplink bandwidth allocation to the terminal 102-1 over satellite 108 in a periodic and ongoing manner. The terminal 102-1 can ignore or discard allocations that are provided by the IGM 110 and no data is requested for by the client device 104-1.

However, once the client device 104-1 requests for data from the gateway 103 through the terminal 102-1, the terminal 102-1 can execute stages (O) through (P) for subsequent data from the gateway 103 to fill the buffer of the application at client device 104-1. Thus, stages (B)-(K) and (O)-(P) repeat indefinitely while the client device 104—continues to execute its application. In this manner, the terminal 102-1 does not need to request for uplink bandwidth allocation, such as the function performed in stage (K), each time the client device 104-1 requests for additional data to fill its buffer.

During stage (Q), when the application at client device 104-1 closes or ceases, the terminal 102-1 can transmit a request to the IGM 110 indicating that the corresponding reservation is no longer needed. The request to the IGM 110 indicating that the corresponding reservation is no longer needed is transmitted in a similar manner as the transmission performed at stage (P). Here, the terminal 102-1 transmits the data in the TDMA frame over the satellite 108 to the gateway 103.

Moreover, the conclusion of the application executed on the client device 104-1 requires the terminal 102-1 to consistently track the streaming flow that was created to the client device 104-1. The flow of packets including the streaming media contains the destination IP, destination port, source IP, and source port. For example, when a connection is created between the Internet Service Provider 118 and the client device 104-1, the source IP address at the source port of the client device 104-1 attempts to contact the destination IP address at the destination port of the Internet Service Provider 118. If the destination IP address needs to respond to the source IP address, the Internet Service Provider 118 generates a new packet, setting itself as the source, and the source IP address (of the client device 104-1) now becomes the destination IP address. Tracking these flow of packets enables the terminal 102-1 to observe both sides of the communication. Each party, e.g., client device 104-1 and the Internet Service Provider 118, can choose to terminate the connection by sending specific flags via the TCP header. If the header contains either an RST, e.g., a forceful termination flag, or an FIN, e.g., a graceful termination flag, the terminal 102-1 can deduce that the video transmission has concluded. Subsequently, the terminal 102-1 can transmit the request to the IGM 110 that periodic uplink bandwidth allocation is no longer required.

In some implementations, the IGM 110 receives that request from the terminal 102-1 and determines, from the request, that the particular reservation for the terminal 102-1 is to be released. The IGM 110 can identify the reservation from table 126 that the request corresponds and release the uplink bandwidth allocated for the terminal 102-1. For example, the IGM 110 can identify the row 127 from the table 126 and delete the periodic uplink bandwidth allocation. In response, the IGM 110 can release the 40 kbits/sec of bandwidth that was allocated for terminal 102-1 and make that bandwidth available elsewhere. Moreover, the IGM 110 no longer transmits the periodic uplink bandwidth allocation to the terminal 102-1 for that reservation. However, the other reservations included in table 126 are continued.

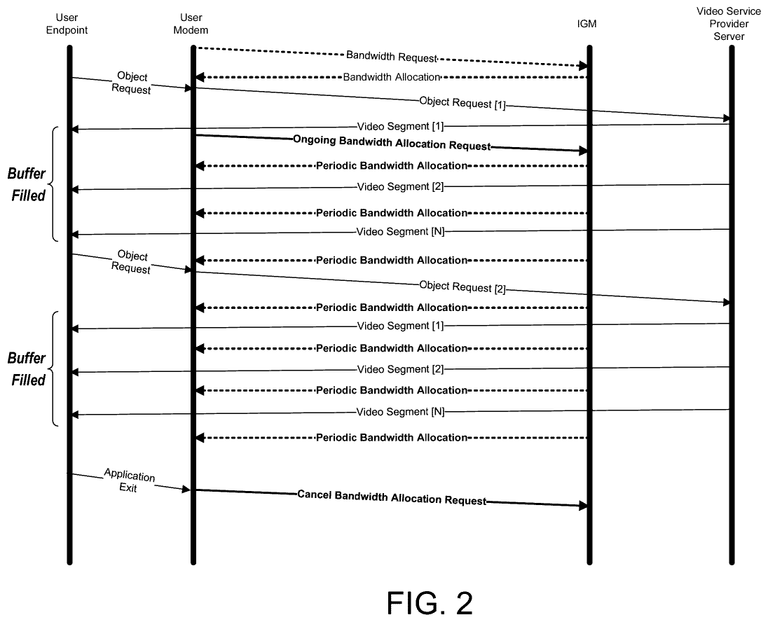

FIG. 2 is a flow diagram that illustrates an example of a flow diagram 200 for creating and distributing periodic uplink bandwidth allocations from a reservation for a terminal. The flow diagram 200 illustrates the nature of the periodic and ongoing uplink bandwidth allocations. The flow diagram 200 is similar to the processes performed in system 100.

The flow diagram 200 includes a user endpoint device, a user modem, an IGM, and a video service provider. These components are similar to the components found in system 100. For example, the user endpoint corresponds to a client device. The user modem corresponds to a terminal. The IGM correspond to IGM 110, and the video service provider server corresponds to the ISP 118. These components communicate in a manner to ensure that uplink bandwidth is allocated in a periodic manner.

First, the user modem transmits a bandwidth request to the IGM. The IGM responds with an uplink bandwidth allocation. The user modem then receives an object request from the user endpoint. The object request corresponds to a request for streaming data to fill in an application on the user endpoint. The user modem transmits the object request on the uplink bandwidth allocation to the IGM. The IGM forwards the object request through to the video service provider server. In response, the video service provider provides the requested video segment back to the IGM. The IGM inserts the DSCP flags into the video segment and forwards the video segment to the user endpoint over the satellite network. These processes are similar to stages (A)-(H).

The user modem receives the video segment and forwards the video segment to the user endpoint. Additionally, the user modem transmits, to the IGM a request for a reservation of periodic and ongoing uplink bandwidth allocations. The IGM creates the reservation based on the request from the user modem. In response, the IGM provides the periodic uplink bandwidth allocations to the user modem. As mentioned, the IGM provides the uplink bandwidth allocations to the user modem in a periodic fashion, such as providing the uplink bandwidth allocations to the user modem every 4 seconds, 5 seconds, or another time. In some cases, the video service provider server continues to provide the video segments requested for by the user endpoint. Once the video service provider server has forwarded each of the video segments to the user endpoint, the application buffer at the user endpoint may be filled. These processes are similar to stages (I)-(P).

Once the buffer has been filled, the application at the user endpoint reads data out of the buffer for consumption. In some cases, after a threshold amount of data has been read from the buffer at the user endpoint, the user endpoint transmits another object request to the user modem, which is subsequently provided to the IGM and the video service provider server. This process continues where the video service provider server provides the video segments back to the user endpoint to fill the buffer. All the while, the IGM continues to provide the periodic bandwidth allocation to the user modem for any future object requests from the user endpoint.

In some implementations, the user endpoint transmits data indicating application exit to the user modem. In response to the user modem receiving the data indicating the application exit, the user modem transmits a message to the IGM. The message indicates to the IGM to cancel the bandwidth allocation request for this particular reservation. The IGM can cancel the reservation in response to receiving the message and release the uplink bandwidth to be used for other terminals and/or other purposes.

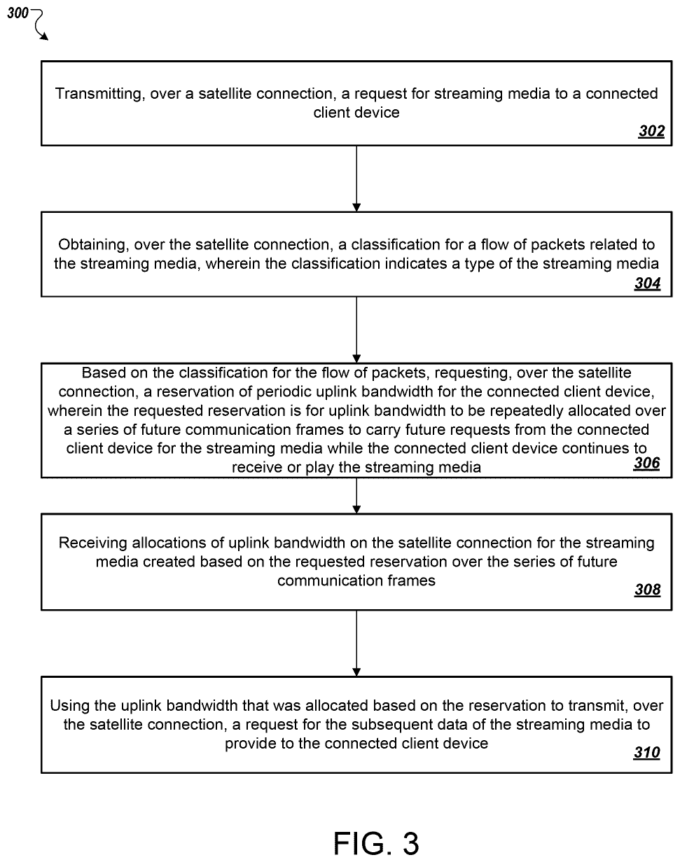

FIG. 3 is a flow diagram that illustrates an example of a process 300 for a terminal to use a requested uplink bandwidth allocation to transmit data for a connected client device. The process 300 can be performed by a terminal, such as terminal 102-1.

The terminal can transmit, over a satellite connection, a request for streaming media to a connected client device (302). In some cases, the terminal can receive a request from a connected client device for initiating streaming media. The request can signal to the terminal that the connected client device launched an application service that presents streaming media at the connected client device. The streaming media can be played through speakers of the connected client device, displayed through a user interface, or transmitted from the client device to a third-party device, such as a television or other device, for example. In response to receiving the request from the connected client device, the terminal can transmit the request over a satellite connection through a satellite and to the gateway.

The terminal can obtain, over the satellite connection, a classification for a flow of packets related to the streaming media, wherein the classification indicates a type of the streaming media (304). Here, the terminal can obtain, from the gateway, a flow of packets related to the streaming media to provide to the connected client device. In response to obtaining the flow of packets, the terminal can determine the classification for the internet protocol flow or flow of packets by identifying within one or more headers of the one or more packets the classification. The classification can indicate the type of the streaming media.

For example, in response to transmitting the request for streaming media to the gateway, the gateway can provide the flow of packets to the terminal and the classification indicative of the streaming media within the flow of packets. The flow of packets may include one or more packets of the streaming media whose headers have been modified by the gateway with the classification. The classification may include, for example, a Differentiated Services Code Point (DSCP) tag. The terminal may analyze the headers of the one or more packets to extract the DSCP tag. Using the DSCP tag, the terminal can determine a particular application executing on the connected client device that transmitted the request for the streaming media. Moreover, by identifying the DSCP tag in the packets, the terminal identifies the arrival of the streaming data and the type of the streaming media requested by the connected client device.

Based on the classification for the flow of packets, the terminal can request, over the satellite connection, for a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media (306). In some cases, the terminal can determine characteristics of the reservation of the periodic uplink bandwidth allocations for the connected client devices, wherein the characteristics include at least one of an amount of bandwidth, a type of service related to the streaming media for the connected client device, and a frequency with which the periodic reservation is to be provided by the gateway. Based on the classification for the flow of packets, the terminal can transmit the request for the reservation of periodic uplink bandwidth for the connected client device and the reservation of periodic uplink bandwidth includes the determined characteristics for creation of the repeated allocations. The repeated allocations are made based on the reservation without subsequent requests from a terminal for the uplink bandwidth for the streaming media.

In some cases, the terminal can request, from the gateway, the reservation of periodic uplink bandwidth allocations for the internet protocol flow before receiving a request from the connected client device for one or more portions of the streaming media. The terminal can request, from the gateway, the reservation of periodic uplink bandwidth allocations for the connected client device which causes the gateway to provide the periodic uplink bandwidth allocations for the flow of packets at a periodic basis until the streaming media is no longer playing, utilized, or active at the connected client device.

For example, a terminal can generate a request to transmit to the gateway for the uplink bandwidth allocations for the connected client device. The generated request can include, for example, an indication that a reservation for periodic uplink bandwidth allocations is requested for the particular terminal, a requested amount of uplink bandwidth over a series of future communication frames, and the type of streaming service being utilized for this uplink. In some cases, the terminal may include the frequency with which the gateway should transmit the periodic bandwidth allocation. The terminal can modulate data of the request using a designated modulation scheme and transmit the modulated request to the gateway over the satellite at a particular carrier frequency. For example, the particular amount of bandwidth can include 40 kbits/sec.

In some cases, the terminal can utilize a local classifier to determine and output data representing the flow of packets related to the streaming media. For instance, the terminal can provide, to the local classifier, data related to the flow of packets for the streaming media. The local classifier is trained to analyze the flow of packets to detect at least one of (i) the classification for the flow of packets related to the streaming media, (ii) detection of streaming video related to the streaming media, and (iii) a type of service utilized at the connected client device for the streaming media. Based on the output data representing the flow of packets related to the streaming media, the terminal can request, from the gateway, the reservation of periodic uplink bandwidth allocations for the flow of packets.

The terminal can receive allocations of uplink bandwidth on the satellite connection for the streaming media created based on the requested reservation over the series of future communication frames (308). In response to transmitting the request to the gateway, the terminal can receive, from an inroute group manager at the gateway and over the satellite connection, the reservation of periodic uplink bandwidth at a designated interval over a series of communication frames. Here, the allocations are provided by the inroute group manager to the terminal on a periodic and ongoing basis so that the terminal does not need to request for an uplink bandwidth allocation. The terminal can utilize the allocation of uplink bandwidth on an as-needed basis. If the terminal does not need the allocation of uplink bandwidth when the inroute group manager provisions the periodic bandwidth, then the terminal can discard or ignore the allocation and wait for the next allocation. Alternatively, if the terminal does need the allocation of uplink bandwidth, then the allocation is available for use.

In some cases, the allocation of uplink bandwidth from the inroute group manager can include a timing and amount of bandwidth for the terminal to utilize for transmitting a request for subsequent streaming data. For example, the timing may indicate which slots in one or more TDMA frames the terminal can utilize for transmitting the request for subsequent streaming data. The amount of bandwidth can include, for example, 40 kbits/sec or another bandwidth amount.

The terminal can use the uplink bandwidth that was allocated based on the reservation to transmit, over the satellite connection, a request for subsequent data of the streaming data to provide to the connected client device (310). For instance, in response to the terminal receiving the received uplink bandwidth that was allocated based on the reservation to transmit the request for subsequent data of the streaming media, the terminal can perform the following actions. The terminal can determine whether demand exists from the connected client device for the subsequent data of the streaming media. In response to the terminal determining that the demand does not exist from the connected client device for the subsequent data, the terminal can discard the uplink bandwidth that was allocated based on the reservation to transmit the request for subsequent data of the streaming media. Alternatively, in response to the terminal determining that the demand does exist from the connected client device for subsequent data, the terminal can transmit, over the satellite connection, a request for the subsequent data of the streaming media using the uplink bandwidth.

In some examples, if the terminal determines that demand does exist from the connected client device for subsequent data, the terminal can insert data from the client device's request into one or more slots of a TDMA frame or into one or more slots across multiple TDMA frames. Similarly, other terminals can insert data of their respective client device's request into the TDMA frames. After the terminals insert the data into their respective slots, the terminals can transmit a TDMA data structure to the gateway through the satellite.

In response, the gateway can forward the request to the internet service provider. Once the gateway receives the subsequent data from the internet service provider, the gateway forwards the subsequent data to the terminal through the satellite, who forwards the data to the connected client device. Similarly, the gateway continues to provide the uplink bandwidth allocations to the terminal in a periodic manner until the terminal signals to the gateway that the uplink bandwidth allocations are no longer required.

In some cases, the terminal can monitor the flow of packets provided to the connected client device from the gateway. The terminal can determine a change in the flow of packets based on the monitoring. Determining the change in the flow of packets can include one or more of the following functions: (i) the terminal can determine a change in classification of the flow of packets related to the streaming media over a period of time; (ii) the terminal can determine a change in an amount of traffic of the flow of packets related to the streaming media; the terminal can determine an end of the flow of packets based on the monitoring; the terminal can determine a change in an internet protocol connection at the gateway related to the flow of packets; or, the terminal can determine the connected client device cancels the flow of packets related to the streaming media. In response to determining the change in the flow of packets, the terminal can transmit a cancellation of the periodic reservation of uplink bandwidth for the flow of packets.

In some cases, the terminal monitoring the internet protocol flow provided to the connected client device from the gateway can include determining a classification of different usages of the flow of packets. The terminal can determine different usages of the internet protocol flow that includes, for example, video playback, advertisement playback, interactive browsing, and one or more previews. In some cases, the terminal can determine, based on the classification of the different usages of the flow of packets, characteristics of the periodic reservation of the uplink bandwidth for the flow of packets. The characteristics of the periodic reservation of the uplink bandwidth includes different allocation based on the different usages of the flow of packets.

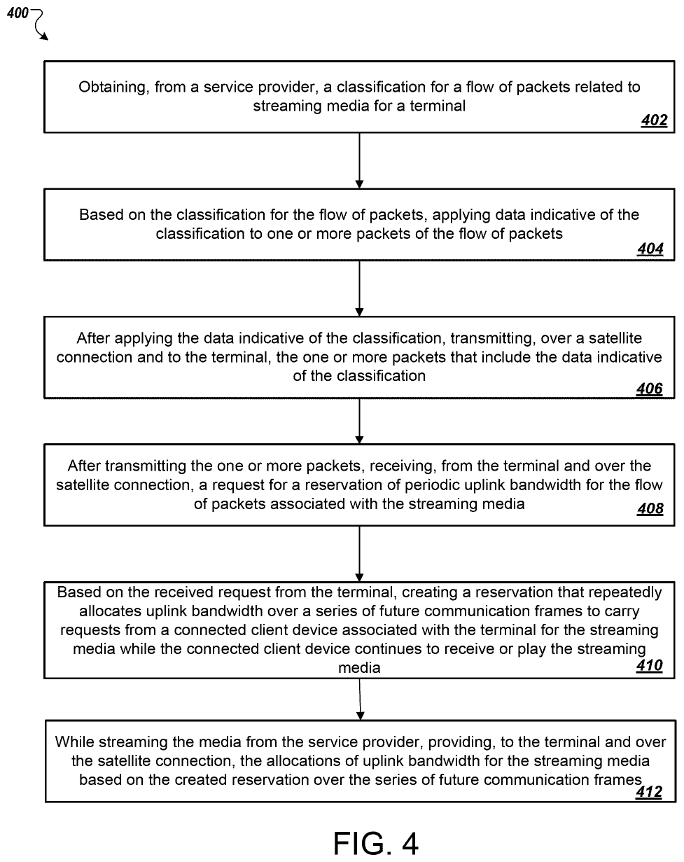

FIG. 4 is a flow diagram that illustrates an example of a process 400 for a gateway system to create and provide periodic uplink bandwidth allocations for a terminal. The process 300 can be performed by a gateway, such as gateway 103.

The gateway can obtain, from a service provider, a classification for a flow of packets related to streaming media for a terminal (402). In some cases, the gateway can provide, to a service provider, a request for streaming media over a network. The gateway can receive, from the service provider, the internet protocol flow related to the streaming media or a flow of one or more packets over TCP from the service provider and over the network. The gateway can utilize a deep packet inspection module, for example, to classify the internet protocol flow. The deep packet inspection module can classify the internet protocol flow by analyzing the one or more packets and output data indicative of a number that represents a particular service type, and a statistical confidence that represents how confidence the trained machine learning model is in detecting a service type.

Based on the classification for the flow of packets, the gateway can apply data indicative of the classification to one or more packets of the flow of packets (404). In response to classifying the flow of packets, the gateway can apply a value indicative of the type of streaming media. The value of the classification can be a flag, a bit mask, another data packet, or another data type. For example, the value can include a Differentiated Services Code Point (DSCP). The gateway can apply the tag to the one or more packets using, for example, bit masking, XOR'ing, and summation between the values of the header and the bit representation version of the header.

After applying the data indicative of the classification, the gateway can transmit, over a satellite connection and to the terminal, the one or more packets that include the data indicative of the classification (406). The one or more packets, which include the DSCP tag, can be transmitted to the terminal by a satellite gateway.

In some cases, the gateway can detect a priority of the flow of packets using the obtained classification for the flow of packets related to the streaming media. Based on the detected priority, the gateway can apply the obtained classification for the flow of packets to one or more categorizations. The one or more categorizations can include, for example, bulk, streaming, interactive, and conversational. The gateway can determine an amount of available bandwidth across each of the terminals in the satellite communication network. In response, the gateway can generate a bandwidth amount for the flow of packets based on the assigned priority of the flow of packets and the amount of available bandwidth across the plurality of terminals. The bandwidth amount corresponds to the amount of bandwidth allocated to the gateway to transmit data in an outroute to the terminal over the satellite. Then, the gateway can transmit, over the satellite network and to the respective terminal, the flow of packets related to the streaming media using the generated bandwidth amount based on the assigned priority of the internet protocol flow.

After transmitting the one or more packets, the gateway can receive, from the terminal and over the satellite connection, a request for a reservation of periodic uplink bandwidth for the flow of packets associated with the streaming media (408). In some cases, the request for the reservation of the periodic uplink bandwidth includes a requested amount of periodic uplink bandwidth, a type of service utilizing the streaming media at a client device connected to the terminal, and a frequency with which the gateway is to provide the requested amount of periodic uplink bandwidth to the terminal.

Based on the received request from the terminal, the gateway can create the reservation that repeatedly allocates uplink bandwidth over the series of future communication frames to carry requests from a connected client device associated with the terminal for the streaming media while the connected client device continues to receive or play the streaming media (410). For instance, the gateway can create the reservation that repeatedly allocates the uplink bandwidth over the series of future communication frames in a data table. The data table, managed by the gateway, can store one or more different allocations of uplink bandwidth for a plurality of terminals in a satellite network, such as one or more reservations. The data table can specify the current reservations created for the terminals, and each reservation of the table can include, for example, data identifying the terminal that requested the reservation, the amount of uplink bandwidth allocated for that reservation, the type of service the reservation is servicing, and the periodicity or frequency with which to provide the uplink bandwidth allocation.

While streaming media from the service provider, the gateway can provide, to the terminal and over the satellite connection, the allocations of uplink bandwidth for the streaming media based on the created reservation over the series of future communication frames (412). In some cases, the gateway can transmit, to the terminal, the created allocations of uplink bandwidth for the streaming that causes the terminal to selectively use the received allocated bandwidth provided for the internet protocol flow based on the reservation to request for subsequent data of the streaming media to provide to a client device connected to the terminal.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more communication devices, the method comprising:
transmitting, over a satellite connection, a request for streaming media to a connected client device;
obtaining, over the satellite connection, a classification for a flow of packets related to the streaming media, wherein the classification indicates a type of the streaming media;
based on the classification for the flow of packets, requesting, over the satellite connection, a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media;
receiving allocations of uplink bandwidth on the satellite connection for the streaming media created based on the requested reservation over the series of future communication frames; and
using the uplink bandwidth that was allocated based on the reservation to transmit, over the satellite connection, a request for subsequent data of the streaming media to provide to the connected client device.

2. The method of claim 1, wherein the repeated allocations are made based on the reservation without subsequent requests from a terminal for the uplink bandwidth for the streaming media.

3. The method of claim 1, wherein transmitting the request for the streaming media to the connected client device comprises transmitting, over the satellite connection, the request for streaming media to the connected client device for an application service that presents the streaming media at the connected client device.

4. The method of claim 1, wherein obtaining the classification for the flow of packets related to the streaming media comprises:
obtaining, over the satellite connection, the flow of packets related to the streaming media to provide to the connected client device; and
determining the classification for the flow of packets by identifying the classification within one or more headers of the flow of packets, wherein the classification indicates the type of the streaming media.

5. The method of claim 4, wherein determining the classification for the flow of packets by identifying the classification within the one or more headers of the flow of packets comprises determining a Differentiated Services Code Point (DSCP) that identifies the type of the streaming media requested by the connected client device.

6. The method of claim 1, wherein requesting, over the satellite connection, the reservation of the periodic uplink bandwidth for the connected client device comprises:
determining characteristics of the reservation of the periodic uplink bandwidth for the connected client device, wherein the characteristics comprise at least one of an amount of bandwidth, a type of service related to the streaming media for the connected client device, and a frequency with which the periodic reservation is to be provided; and
based on the classification for the flow of packets, transmitting, over the satellite connection, a request for the reservation of periodic uplink bandwidth for the connected client device, wherein the request for the reservation of periodic uplink bandwidth comprises the determined characteristics for creation of the repeated allocations.

7. The method of claim 1, wherein the reservation is requested comprises based on the classification for the flow of packets, requesting, over the satellite connection, the reservation of periodic uplink bandwidth for the connected client device before receiving a request from the connected client device for one or more portions of the streaming media.

8. The method of claim 7, wherein the reservation is requested while the connected client device continues to receive or play the streaming media comprises requesting, over the satellite connection, the reservation of periodic uplink bandwidth for the connected client device which causes a gateway to provide the repeated allocation of the uplink bandwidth for the connected client device at a periodic basis until the streaming media is no longer played at the connected client device.

9. The method of claim 1, wherein receiving the allocations of uplink bandwidth on the satellite connection for the streaming media based on the requested reservation over the series of future communication frames comprises receiving, from an inroute group manager at a gateway and over the satellite connection, the allocations of uplink bandwidth at a designated interval over the series of the future communication frames.

10. The method of claim 1, wherein using the uplink bandwidth that was allocated based on the reservation to transmit the request for subsequent data of the streaming media to provide to the connected client device comprises:
in response to receiving the uplink bandwidth that was allocated based on the reservation to transmit the request for subsequent data of the streaming media:
determining whether demand exists from the connected client device for the subsequent data of the streaming media; and
in response to determining the demand does not exist from the connected client device for the subsequent data, discarding the uplink bandwidth that was allocated based on the reservation to transmit the request for subsequent data of the streaming media; or
in response to determining the demand does exist from the connected client device for the subsequent data, transmitting, over the satellite connection, a request for the subsequent data of the streaming media using the uplink bandwidth.

11. The method of claim 1, further comprising:
monitoring the flow of packets provided to the connected client device;
determining a change in the flow of packets based on the monitoring, wherein determining the change in the flow of packets comprises at least of:
determining a change in classification of the flow of packets related to the streaming media over a period of time;
determining a change in an amount of traffic of the flow of packets related to the streaming media;
determining an end of the flow of packets based on the monitoring;
determining a change in an internet protocol connection at a gateway related to the flow of packets; or
determining the connected client device cancels the flow of packets related to the streaming media; and
in response to determining the change in the flow of packets, transmitting, to the gateway, a cancellation of the periodic reservation of uplink bandwidth for the flow of packets.

12. The method of claim 1, wherein requesting the reservation of periodic uplink bandwidth for the connected client device comprises requesting for a particular amount of bandwidth for the periodic uplink bandwidth over the series of future communication frames.

13. The method of claim 12, wherein the particular amount of bandwidth for the periodic uplink bandwidth comprises 40 kilobits.

14. The method of claim 1, further comprising:
determining a classification of different usages of the flow of packets, wherein the different usages comprise video playback, advertisement playback, interactive browsing, and one or more previews; and
determining, based on the classification of the different usages of the flow of packets, characteristics of the reservation of the periodic uplink bandwidth for the flow of packets, wherein the characteristics of the reservation of the periodic uplink bandwidth includes different allocations based on the different usages of the flow of packets.

15. The method of claim 1, further comprising:
providing, to a local classifier, data related to the flow of packets for the streaming media;
obtaining, from the local classifier, output data representing the flow of packets related to the streaming media, wherein the local classifier is trained to analyze the flow of packets to detect at least one of (i) the classification for the flow of packets related to the streaming media, (ii) detection of streaming video related to the streaming media, and (iii) a type of service utilized at the connected client device for the streaming media; and
based on the output data representing the flow of packets related to the streaming media, requesting, over the satellite connection, the reservation of periodic uplink bandwidth for the flow of packets.

16. A terminal comprising;
one or more processors and one or more storage devices storing instructions that are operable, when executed by the one or more processors, to cause the terminal to perform operations comprising:
transmitting, over a satellite connection, a request for streaming media to a connected client device;
obtaining, over the satellite connection, a classification for a flow of packets related to the streaming media, wherein the classification indicates a type of the streaming media;
based on the classification for the flow of packets, requesting, over the satellite connection, a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media;
receiving allocations of uplink bandwidth on the satellite connection for the streaming media created based on the requested reservation over the series of future communication frames; and
using the uplink bandwidth that was allocated based on the reservation to transmit, over the satellite connection, a request for subsequent data of the streaming media to provide to the connected client device.

17. The terminal of claim 16, wherein the repeated allocations are made based on the reservation without subsequent requests from a terminal for the uplink bandwidth for the streaming media.

18. The terminal of claim 16, wherein transmitting the request for the streaming media to the connected client device comprises transmitting, over the satellite connection, the request for streaming media to the connected client device for an application service that presents the streaming media at the connected client device.

19. The terminal of claim 16, wherein obtaining the classification for the flow of packets related to the streaming media comprises:
obtaining, over the satellite connection, the flow of packets related to the streaming media to provide to the connected client device; and
determining the classification for the flow of packets by identifying the classification within one or more headers of the flow of packets, wherein the classification indicates the type of the streaming media.

20. One or more storage devices storing instructions that are operable, when executed by one or more processors, to cause the one or more processors to perform operations comprising:
transmitting, over a satellite connection, a request for streaming media to a connected client device;
obtaining, over the satellite connection, a classification for a flow of packets related to the streaming media, wherein the classification indicates a type of the streaming media;
based on the classification for the flow of packets, requesting, over the satellite connection, a reservation of periodic uplink bandwidth for the connected client device, wherein the requested reservation is for uplink bandwidth to be repeatedly allocated over a series of future communication frames to carry future requests from the connected client device for the streaming media while the connected client device continues to receive or play the streaming media;
receiving allocations of uplink bandwidth on the satellite connection for the streaming media created based on the requested reservation over the series of future communication frames; and
using the uplink bandwidth that was allocated based on the reservation to transmit, over the satellite connection, a request for subsequent data of the streaming media to provide to the connected client device.
